(19) United States
(12) Patent Application Publication
(10) Pub. No.: US 2026/0112226 A1
(43) Pub. Date: Apr. 23, 2026

(54) CASH HANDLING APPARATUS, CASH HANDLING METHOD, AND CASH HANDLING PROGRAM

(71) Applicants: FUJITSU FRONTECH LIMITED, Tokyo (JP); Fujitsu Frontech Systems Limited, Maebashi-shi, Gunma (JP)

(72) Inventors: Hiroshi NAKANO, Inagi (JP); Kazuhisa YOSHIMURA, Inagi (JP)

(73) Assignees: FUJITSU FRONTECH LIMITED, Inagi-shi, Tokyo (JP); Fujitsu Frontech Systems Limited, Maebashi-shi (JP)

(21) Appl. No.: 19/415,316

(22) Filed: Dec. 10, 2025

Related U.S. Application Data
(63) Continuation of application No. PCT/JP2023/023415, filed on Jun. 23, 2023.

(51) Int. Cl. G07D 11/34; G07D 11/225; G07D 11/23; G07D 11/50

(52) U.S. Cl. CPC G07D 11/34; G07D 11/225; G07D 11/23; G07D 11/50

(57) ABSTRACT

A cash handling apparatus includes, a banknote storage that stores banknotes, a memory, and a processor coupled to the memory and configured to, calculate a first increase or decrease on the basis of information on entrance and exit of banknotes to and from the banknote storage, calculate a second increase or decrease on the basis of physical quantity that varies according to the number of banknotes stored in the banknote storage, and detect possibility of banknote loss on the basis of the first increase or decrease and the second increase or decrease.

### FIELD

The present invention relates to a cash handling apparatus, a cash handling method, and a cash handling program.

### BACKGROUND

Cash handling apparatuses, such as automatic teller machines (ATMs), which are widely spread among and used by, for example, banks, have been known conventionally. A cash handling apparatus is an apparatus that automatically handles cash withdrawal and deposit transactions according to instructions from customers. There are also other cash handling apparatuses, including self-checkout systems (SCOs) used for self-checkout in supermarkets, for example. Plural cash handling apparatuses are thus arranged in a predetermined area, such as a bank branch, a department store, a supermarket, or a convenience store, to enhance customer convenience.

Loss of cash stored in a cash processing unit installed in such a cash handling apparatus may sometimes occur. For example, a recycle stacker provided in the cash processing unit and storing banknotes to be recycled may be opened and the banknotes stored in the recycle stacker may be stolen.

Cash loss that occurs in cash handling apparatuses has conventionally been detected by careful cash inspections conducted periodically at certain intervals. For example, a close inspection of cash is conducted as follows. A cash handling apparatus calculates the total number of banknotes in its unit from a counter updated in association with banknote movement during operation. The total number of banknotes calculated from information acquired from this counter is called “the calculated total number of banknotes”. Calculation of a calculated total number of banknotes is periodically conducted during the operation in the cash handling apparatus. In the close inspection, all of banknotes in the banknote recycle unit are gathered at one place in the cash handling apparatus and taken out, and these banknotes that have been taken out are counted by a counting machine. This operation of counting the banknotes taken out by means of the counting machine is called “close inspection operation”, and the total number of banknotes acquired by this close inspection operation is called “the actual number of banknotes”. Loss of any banknote has conventionally been detected by a discrepancy between the actual number of banknotes and the calculated number of banknotes at the time of this close inspection.

Furthermore, in a technique that has been proposed as a technique for detecting cash loss in a cash handling apparatus, serial numbers of banknotes deposited are read and stored, serial numbers of banknotes stored in a banknote cassette are reread, and any loss is detected by comparison between the stored serial numbers and the reread serial numbers. Furthermore, in a technique that has been proposed, information on the number of banknotes stored in a stacker is stored in a memory, the number of banknotes stored in the stacker is counted when door key operation in the stacker is detected, and the number information in the memory and the counted number of banknotes are compared with each other. Furthermore, in a technique that has been proposed, paper sheet identification information uniquely identifying paper sheets is acquired from the paper sheets, the paper sheet identification information acquired is transmitted, the paper sheet identification information is received, and paper sheet identification information on any lost paper sheet is determined.
Patent Literature 1: Japanese Laid-open Patent Publication No. 2015-184802
Patent Literature 2: Japanese Laid-open Patent Publication No. 2016-177596
Patent Literature 3: Japanese Laid-open Patent Publication No. 2022-156637

However, in the conventional method of detecting cash loss by a close inspection, work for taking out cash from the cash processing unit is generated in the close inspection operation and cash loss detection itself thus takes time. Furthermore, even if any cash loss is detected, there has been an elapse of time from the actual occurrence of the loss to the close inspection and determining the cause of the cash loss and the time and date of the occurrence is thus difficult. Therefore, improving the security of cash management is difficult.

Furthermore, with the technique for detecting any loss on the basis of serial numbers, tracking serial numbers of banknotes replenished and banknotes taken out from the collection stacker is difficult and detecting any loss for all of banknotes in the cash processing unit is thus difficult. The same applies to the technique for detecting any loss on the basis of paper sheet identification information. Furthermore, with the technique for detecting any cash loss by counting the number of banknotes stored in the stacker, the counting being triggered by door key operation in the stacker, cash loss is not detected until key operation is performed and determining the cause of the cash loss and the date and time of the occurrence is thus difficult. Even if any of these techniques is used, improving the security of cash management is thus difficult.

Techniques disclosed herein are implemented in view of the above and an object thereof is to provide a cash handling apparatus, a cash handling method, and a cash handling program that enable security of cash management to be improved.

### SUMMARY

According to an aspect of an embodiment, a cash handling apparatus includes, a banknote storage that stores banknotes, a memory, and a processor coupled to the memory and configured to, calculate a first increase or decrease on the basis of information on entrance and exit of banknotes to and from the banknote storage, calculate a second increase or decrease on the basis of physical quantity that varies according to the number of banknotes stored in the banknote storage, and detect possibility of banknote loss on the basis of the first increase or decrease and the second increase or decrease.

### BRIEF DESCRIPTION OF DRAWINGS

FIG. 1 is a diagram illustrating an example of a hardware configuration of a cash handling apparatus.

FIG. 2 is a schematic diagram illustrating a structure of a cash processing unit.

FIG. 3 is a block diagram of the cash handling apparatus.

FIG. 4 is a diagram illustrating a schema of a recycle stacker having a roll-type banknote storage mechanism.

FIG. 5 is a schematic diagram of a rotation mechanism of a roll.

FIG. 6 is a diagram illustrating relations between the numbers of banknotes and diameters of the roll for deposits and withdrawals.

FIG. 7 is a diagram illustrating an example of a table for conversion of diameters of the roll to the numbers of banknotes.

FIG. 8 is a diagram illustrating an example of detection of possibility of occurrence of cash loss.

FIG. 9 is a diagram illustrating an example of questionable time periods that are able to be determined from log information.

FIG. 10 is a flowchart of a cash loss detection process by the cash handling apparatus according to an embodiment.

FIG. 11 is a diagram illustrating differences between banknote storage methods for a roll-type banknote storage mechanism and a stacking-type banknote collection mechanism.

### DESCRIPTION OF EMBODIMENT

An embodiment of a cash handling apparatus, a cash handling method, and a cash handling program, disclosed by the present application will hereinafter be described in detail, on the basis of the drawings. The cash handling apparatus, the cash handling method, and the cash handling program disclosed by the present application are not to be limited by the following embodiment.

### Embodiment

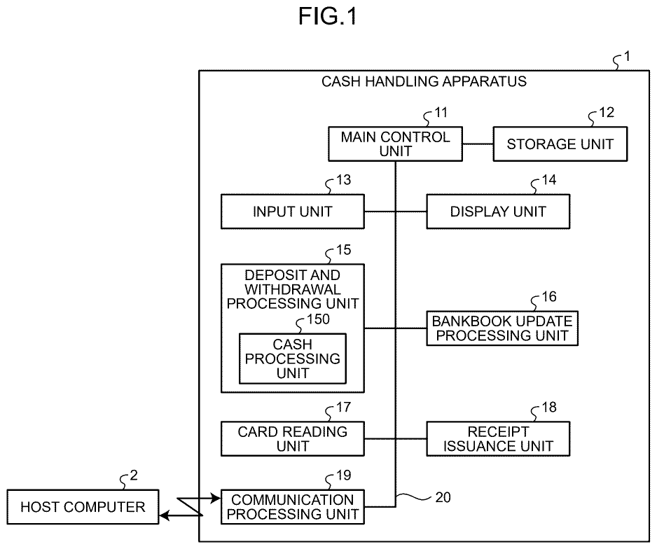

FIG. 1 is a diagram illustrating an example of a hardware configuration of a cash handling apparatus. A cash handling apparatus 1 has, as illustrated in FIG. 1, a main control unit 11, a storage unit 12, an input unit 13, a display unit 14, a deposit and withdrawal processing unit 15, a bankbook update processing unit 16, a card reading unit 17, a receipt issuance unit 18, and a communication processing unit 19. The main control unit 11, the storage unit 12, the input unit 13, the display unit 14, the deposit and withdrawal processing unit 15, the bankbook update processing unit 16, the card reading unit 17, the receipt issuance unit 18, and the communication processing unit 19 are connected to one another by a bus 20.

The input unit 13 and the display unit 14 include a customer operation screen. A user refers to various screens displayed on the display unit 14 and performs operation to select and input a desired transaction by using the input unit 13, for example.

When service for the transaction selected by the user is provided, for example, the communication processing unit 19 is used in communication with a host computer 2 via a network. The communication processing unit 19 is, for example, a communication interface.

The main control unit 11 integrally controls the cash handling apparatus 1. The main control unit 11 reads a program that has been stored in the storage unit 12, for example, and that is for executing various processes for the cash handling apparatus 1; temporarily stores the program read into an internal memory (not illustrated in the drawings); and executes the various processes according to this program. The main control unit 11 has, for example, a central processing unit (CPU).

For example, the main control unit 11 performs control to implement a transaction specified by a user operating the input unit 13. Specifically, in response to a user selecting and inputting a transaction by means of the input unit 13 from a transaction menu displayed on the display unit 14, inserting a card or a bankbook, and performing predetermined transaction operation, the main control unit 11 performs, via the communication processing unit 19, control to implement the transaction with the host computer 2 that manages various kinds of information, such as user account information, personal identification numbers, and deposit amounts.

The storage unit 12 stores an application program for executing various processes at the cash handling apparatus 1 and data needed in the processes at the cash handling apparatus 1, for example. The storage unit 12 is, for example, a hard disk drive.

The deposit and withdrawal processing unit 15 has a cash processing unit 150. The cash processing unit 150 implements conveyance of banknotes and storage of banknotes. For example, the cash processing unit 150 receives banknotes inserted by users and implements conveyance, discrimination, counting, and storage of the banknotes. Furthermore, the cash processing unit 150 dispenses a given number of banknotes from a cash deposit and withdrawal slot according to a withdrawal transaction selected by a user. The cash processing unit 150 may perform a process of receiving coins inserted and discriminating, counting, and storing the coins or a process of dispensing a given number of coins from the cash deposit and withdrawal slot according to a withdrawal transaction selected by a user.

The bankbook update processing unit 16 receives a bankbook inserted by a user from a bankbook reception slot and conveys the bankbook to a predetermined position, record transaction details in the bankbook, and returns the updated bankbook from the bankbook reception slot.

The card reading unit 17 receives a card inserted from a card reception slot by a user, performs reading of data, such as account information, from a magnetic stripe or an integrated circuit (IC) chip on the card, and returns the card from the card reception slot. The receipt issuance unit 18 issues a receipt.

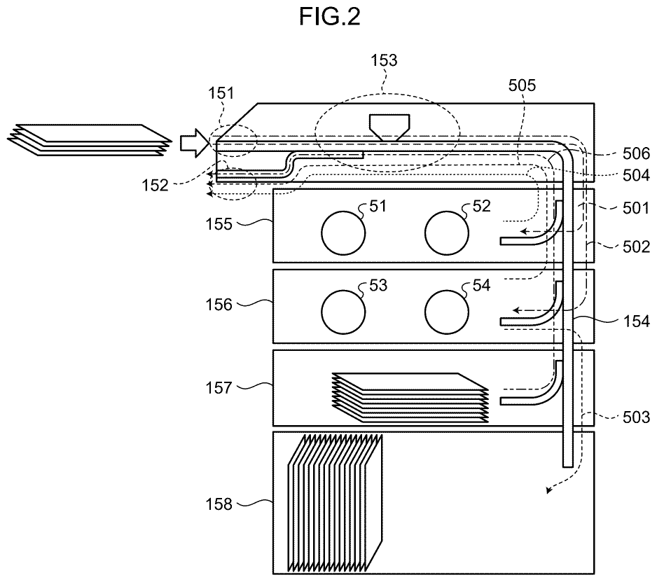

FIG. 2 is a schematic diagram illustrating a structure of a cash processing unit. The cash processing unit 150 has a deposit unit 151, a withdrawal unit 152, a banknote discrimination unit 153, a banknote conveyance mechanism 154, recycle stackers 155 and 156, a replenishment stacker 157, and a collection stacker 158, which are illustrated in FIG. 2. Furthermore, the cash processing unit 150 has a processor and a memory that are not illustrated in the drawings.

The deposit unit 151 is a mechanism to receive any deposited banknote. The withdrawal unit 152 is a mechanism to dispense any withdrawn banknote. The banknote discrimination unit 153 performs discrimination of any banknote inserted to determine whether the banknote is genuine or counterfeit and the banknote is recyclable or not, for example.

The recycle stackers 155 and 156 store banknotes that have been recycled to be used in withdrawals, the banknotes being from banknotes deposited. In an embodiment, the recycle stackers 155 and 156 have roll-type banknote storage mechanisms. The recycle stacker 155 has rolls 51 and 52 to store banknotes. Furthermore, the recycle stacker 156 has rolls 53 and 54 to store banknotes.

FIG. 2 illustrates a case where the cash processing unit 150 has two recycle stackers, the recycle stackers 155 and 156, but the number of recycle stackers installed may be one or three or more. Furthermore, as to the rolls 51 and 52, the number of rolls to be installed in the one recycle stacker 155 may be one or three or more. The recycle stackers 155 and 156 each correspond to an example of a “banknote storage unit”.

The replenishment stacker 157 is used for a withdrawal in a case where banknotes accumulated in the recycle stacker 155 have run short. The replenishment stacker 157 stores banknotes that have been supplied externally. By putting banknotes in the replenishment stacker 157 and setting the replenishment stacker 157 in the cash handling apparatus 1, an administrator of the cash handling apparatus 1 is able to replenish the cash handling apparatus 1 with the banknotes.

The collection stacker 158 stores banknotes that are not used in recycling. The banknotes stored in the collection stacker 158 are taken out externally and collected, without being withdrawn.

The banknote conveyance mechanism 154 moves a banknote between the deposit unit 151, the withdrawal unit 152, the recycle stacker 155, the recycle stacker 156, the replenishment stacker 157, and the collection stacker 158. For example, via a path 501, the banknote conveyance mechanism 154 sends a banknote inserted in the deposit unit 151 to the recycle stacker 155 for accumulation. Furthermore, via a path 502, the banknote conveyance mechanism 154 sends a banknote inserted in the deposit unit 151 to the recycle stacker 156 for accumulation. Furthermore, via a path 503, the banknote conveyance mechanism 154 moves a banknote from the recycle stacker 156 to the collection stacker 158. Furthermore, via a route 504, the banknote conveyance mechanism 154 sends a banknote from the recycle stacker 155 to the withdrawal unit 152. Furthermore, via a route 505, the banknote conveyance mechanism 154 sends a banknote from the recycle stacker 156 to the withdrawal unit 152. Furthermore, via a route 506, the banknote conveyance mechanism 154 sends a banknote from the recycle stacker 157 to the withdrawal unit 152. The above mentioned paths are just an example, and the banknote conveyance mechanism 154 may move banknotes using other paths.

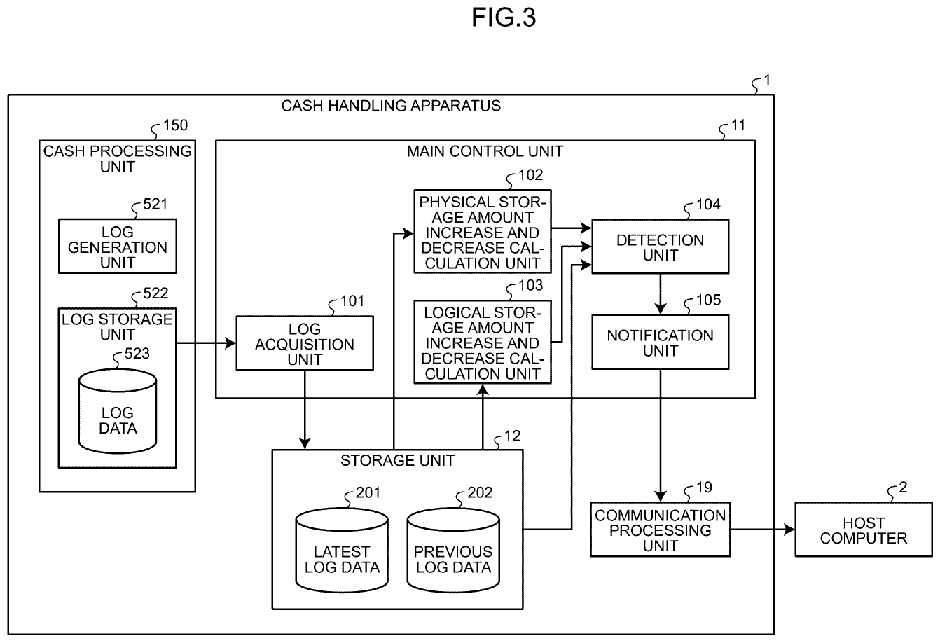

FIG. 3 is a block diagram of the cash handling apparatus. The cash handling apparatus 1 detects possibility of occurrence of cash loss that is loss of any banknote stored in the cash handling apparatus 1. The cash handling apparatus 1 detects that cash loss is suspected and there is possibility of the cash loss, but this detection of possibility of cash loss may hereinafter be simply referred to as “detection of cash loss”. FIG. 3 illustrates functions related to the detection of cash loss in the cash handling apparatus 1 and illustration of other functions has been omitted. The detection of cash loss by the cash handling apparatus 1 will be described hereinafter by reference to FIG. 3.

As illustrated in FIG. 3, the cash processing unit 150 of the cash handling apparatus 1 has a log generation unit 521 and a log storage unit 522. The log generation unit 521 is implemented by a processor that the cash processing unit 150 has. Furthermore, the log storage unit 522 is implemented by, for example, a memory that the cash processing unit 150 has.

The log generation unit 521 records a log indicating operation and a state of the cash processing unit 150 into log data 523 held by the log storage unit 522, from information acquired by controlling and monitoring the operation of the cash processing unit 150. For example, the log generation unit 521 records information on whether the power is on or off and whether the recycle stackers 155 and 156 have been removed or attached, into the log data 523. In addition, the log generation unit 521 records, for example, information acquired from the number of times passage of a banknote is detected by a sensor provided at each location in the cash processing unit 150 and diameters of rolls found from control information on pulse motors for rotating the rolls, into the log data 523.

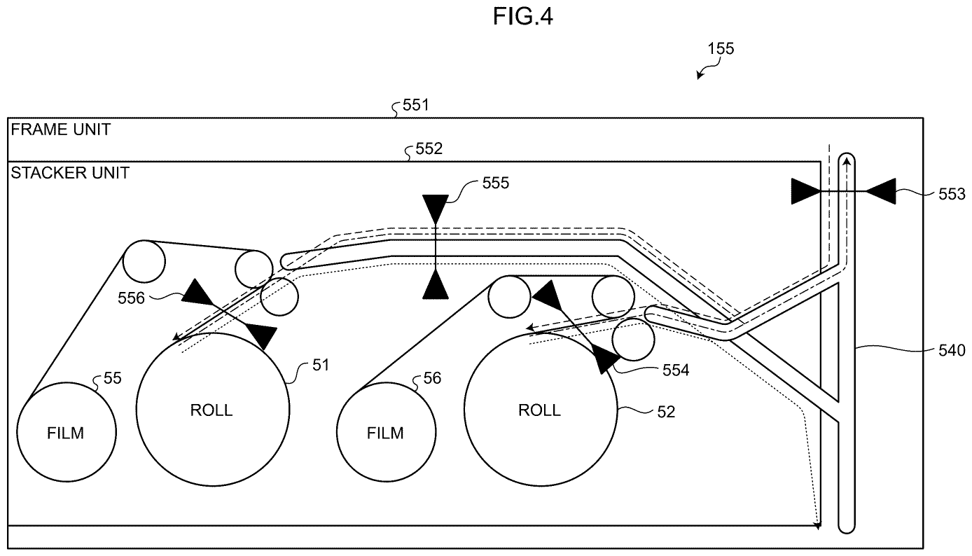

The following description is on an example of these sensors. FIG. 4 is a diagram illustrating a schema of a recycle stacker having a roll-type banknote storage mechanism. The recycle stacker 155 will be described herein as an example.

The recycle stacker 155 has a frame unit 551 and a stacker unit 552. The frame unit 551 is fixed to the cash handling apparatus 1. The stacker unit 552 is attachable to and detachable from the frame unit 551. The roll 51 stores a banknote by winding the banknote around the roll 51, with the banknote put between a film 55 and the roll 51. Similarly, the roll 52 stores a banknote by winding the banknote around the roll 52, with the banknote put between a film 56 and the roll 52.

Furthermore, the recycle stacker 155 has a conveyance path 540 for sending a banknote to the roll 51 or 52. Sensors 553 to 556 that detect passage of a banknote are provided on the conveyance path 540, at a winding inlet for the film 55 at the roll 51, and at a winding inlet for the film 56 at the roll 52.

The log generation unit 521 is capable of detecting entrance and exit of banknotes to and from the rolls 51 and 52 of the recycle stacker 155 by using results of detection of passage of the banknotes by the sensors 553 to 556. The following description is on calculation of the numbers of banknotes that have entered and exited the roll 51, for example. The log generation unit 521 has a counter that counts entrance of banknotes one by one and a counter that counts exit of banknotes one by one, for each of the rolls 51 and 52 and the log generation unit 521 counts entrance and exit of banknotes by using the counters according to the results of the detection of passage of banknotes by the sensors 553 to 556. By counting the entrance and exit of banknotes from a state where the counters are at 0 for each of the rolls 51 and 52, the log generation unit 521 is able to calculate the numbers of banknotes stored respectively in the rolls 51 and 52 at a time point of log generation. The log generation unit 521 then records the numbers of banknotes stored respectively in the rolls 51 and 52 at the time point of log generation, into the log data 523.

Similarly, the log generation unit 521 calculates the numbers of banknotes stored in the rolls 53 and 54 of the recycle stacker 156 and records the numbers of banknotes into the log data 523. In addition, the log generation unit 521 may record the number of banknotes dispensed from the replenishment stacker 157 or the number of banknotes inserted in the collection stacker 158, for example, into the log data 523.

Furthermore, the log generation unit 521 calculates a diameter of each of the rolls 51 to 54 that the recycle stackers 155 and 156 have, by using information acquired through control and monitoring of operation of the recycle stackers 155 and 156 that the cash processing unit 150 has. The log generation unit 521 then records the calculated diameter of each of the rolls 51 to 54, into the log data 523.

Details of the calculation of the diameter of each of the rolls 51 to 54 by the log generation unit 521 will be described hereinafter. The roll 51 that the recycle stacker 155 has will be described herein as an example.

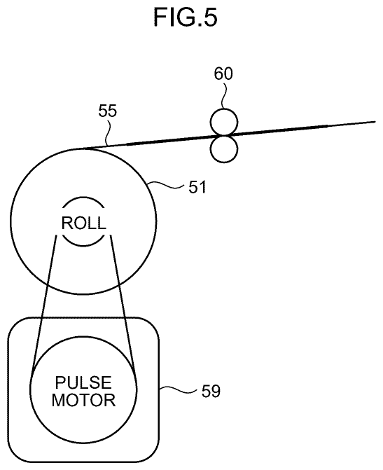

FIG. 5 is a schematic diagram of a rotation mechanism of a roll. The recycle stacker 155 has a pulse motor 59 that rotates the roll 51 as illustrated in FIG. 5 although the pulse motor 59 is omitted in FIG. 2 and FIG. 4. Furthermore, film movement detection rollers 60 for measuring the amount of movement of the film 55 having a banknote or banknotes put therebetween is arranged near the winding inlet, from which the film 55 having the banknote or banknotes put therebetween are wound around the roll 51. The film movement detection rollers 60 generate a predetermined number of movement detection pulses every time the film movement detection rollers 60 rotate once.

The rotation angle of the pulse motor 59 per pulse is fixed. Furthermore, the number of pulses per unit time of a signal given to the pulse motor 59 is controlled by firmware of the cash processing unit 150 so that the movement velocity of the film 55 remains constant. That is, the pulse motor 59 rotates the roll 51 fast when the diameter is small and rotates the roll 51 slowly when the diameter is large. On the basis of the pulse period for the pulse motor 59 at each time point, the number of rotations of the roll 51 per unit time is able to be found, the pulse period being obtained through control by the cash processing unit 150.

Furthermore, rotation of the pulse motor 59 causes rotation of the roll 51 and causes the film 55 having banknotes put therebetween at regular intervals to be wound around the roll 51. Therefore, increasing the amount of film 55 wound around the roll 51 per pulse increases the amount of banknotes wound around the roll 51. Furthermore, increasing the diameter and the outer circumference of the roll 51 per pulse increases the amount of film 55 wound around the roll 51.

If the numbers of pulses given to the pulse motor 59 are the same, the rotation angles of the roll 51 are equal. In a case where the rotation angles are equal, the larger the diameter of the roll 51, the longer the outer circumference and thus the more increased the amount of film 55 wound around the roll 51. Therefore, the diameter of the roll 51 is able to be found from the number of rotations of the roll 51 per unit time and the amount of movement of the film 55.

The log generation unit 521 thus calculates a diameter of the roll 51 as follows. The log generation unit 521 has information beforehand, the information being on the number of pulses per rotation of the pulse motor 59. Furthermore, the log generation unit 521 has information on a reduction ratio of the roll 51 in relation to the pulse motor 59. Furthermore, the log generation unit 521 holds a pulse period of the pulse motor 59 obtained through control by the cash processing unit 150. Furthermore, the log generation unit 521 has information on the diameter of the film movement detection rollers 60 and on the predetermined number of movement detection pulses generated per rotation thereof. Furthermore, by monitoring the number of movement detection pulses generated from the film movement detection rollers 60, the log generation unit 521 acquires a film movement pulse period corresponding to the number of movement detection pulses generated per unit time.

For example, the log generation unit 521 has “200” as the number of pulses per rotation of the pulse motor 59 and “0.65769” as the reduction ratio of the roll 51 in relation to the pulse motor 59. Furthermore, the log generation unit 521 has “17.2 mm” as the diameter of the film movement detection rollers 60 and “8” as the predetermined number of movement detection pulses.

The log generation unit 521 then divides the number of pulses per rotation of the pulse motor 59 by the reduction ratio to calculate the number of pulses per roll rotation. That is, “the number of pulses per rotation of the roll 51=the number of pulses per rotation of the pulse motor 59/the reduction ratio”.

Furthermore, the log generation unit 521 regards the reciprocal of the pulse period of the pulse motor 59 as the number of pulses per second. That is, “the number of pulses per second=1/the pulse period of the pulse motor 59”. Calculation will hereinafter be performed with one second being regarded as the unit time.

Subsequently, the log generation unit 521 divides the number of pulses per second by the number of pulses per rotation of the roll 51 to find the number of rotations of the roll 51 per second. That is, “the number of rotations of the roll 51 per second=the number of pulses per second/the number of pulses per rotation of the roll 51”.

Furthermore, the log generation unit 521 divides the length of the outer circumference found from the diameter of the film movement detection rollers 60 by the number of rotations of the film movement detection rollers 60 to find the velocity of the film 55. That is, “the velocity of the film 55=(the diameter of the film movement detection rollers 60×π)/(the film movement pulse period×the predetermined number of movement detection pulses generated per rotation of the film movement detection rollers 60)”.

The log generation unit 521 then calculates the length of the outer circumference of the roll 51 by dividing the velocity of the film 55 by the number of rotations of the roll 51 per second. That is, “the length of the outer circumference of the roll 51=the velocity of the film 55/the number of rotations of the roll 51 per second”.

Lastly, the log generation unit 521 calculates the diameter of the roll 51 from the calculated length of the outer circumference of the roll 51. Herein, “the diameter of the roll 51=the length of the outer circumference of the roll 51/π”. Accordingly, the log generation unit 521 is able to find the diameter of the roll 51.

Description will be continued by reference back to FIG. 3. The log storage unit 522 holds the log data 523 having a log recorded therein by the log generation unit 521, the log indicating operation and a state of the cash processing unit 150.

The main control unit 11 of the cash handling apparatus 1 will be described next. The main control unit 11 has a log acquisition unit 101, a physical storage amount increase and decrease calculation unit 102, a logical storage amount increase and decrease calculation unit 103, a detection unit 104, and a notification unit 105.

The log acquisition unit 101 periodically acquires the log data 523 held by the log storage unit 522 of the cash processing unit 150. The log acquisition unit 101 then stores, as latest log data 201, the log data 523 acquired newly and corresponding to the latest log, into the storage unit 12. In storing the latest log data 201, the log acquisition unit 101 leaves the latest log data 201 that have been stored in the storage unit 12 as previous log data 202 in the storage unit 12. In the cash handling apparatus 1 according to the embodiment, the time of this log acquisition by the log acquisition unit 101 is the time of detection of cash loss.

The logical storage amount increase and decrease calculation unit 103 acquires the latest number of banknotes stored in the roll 51 from the latest log data 201. Furthermore, the logical storage amount increase and decrease calculation unit 103 acquires the previous number of banknotes stored in the roll 51 from the previous log data 202. The logical storage amount increase and decrease calculation unit 103 then calculates an increase or decrease in logical storage amount, which is a storage amount logically acquired from the detected numbers of banknotes that entered and exited, by subtracting the previous number of banknotes stored in the roll 51 from the latest number of banknotes stored in the roll 51.

Similarly, the logical storage amount increase and decrease calculation unit 103 calculates an increase or decrease in logical storage amount for each of the rolls 52 to 54. The logical storage amount increase and decrease calculation unit 103 then outputs the calculated increase or decrease in logical storage amount for each of the rolls 51 to 54, to the detection unit 104. This increase or decrease in logical storage amount corresponds to an example of a “first increase or decrease”.

If a difference calculated from the number of banknotes inserted and the number of banknotes dispensed for each of the rolls 51 to 54 has been recorded in each of the latest log data 201 and the previous log data 202, the logical storage amount increase and decrease calculation unit 103 may use that value as the increase or decrease in logical storage amount.

Furthermore, in this embodiment, the entrance and exit of banknotes are detected from results of detection by the sensors 553 to 556 provided in the recycle stacker 155 but the method of counting the number of banknotes inserted and the number of banknotes dispensed is not limited to this detection. For example, the logical storage amount increase and decrease calculation unit 103 may determine the number of banknotes inserted or dispensed by using instructions for insertion of banknotes into the recycle stacker 155 and instructions for dispensing of banknotes from the recycle stacker 155 through an application that operates the cash processing unit 150. In this case, the logical storage amount increase and decrease calculation unit 103 may store the determined number of banknotes inserted or dispensed and find an increase or decrease in logical storage amount from the number of banknotes inserted into the recycle stacker 155 and the number of banknotes dispensed from the recycle stacker 155 without using the latest log data 201 and the previous log data 202.

The physical storage amount increase and decrease calculation unit 102 acquires information on the diameter of each of the rolls 51 to 54 from the latest log data 201. The physical storage amount increase and decrease calculation unit 102 then calculates an increase or decrease in physical storage amount, which is a physical storage amount estimated from the acquired information on the diameter, for each of the rolls 51 to 54. Details of the calculation of an increase or decrease in physical storage amount by the physical storage amount increase and decrease calculation unit 102 will be described hereinafter.

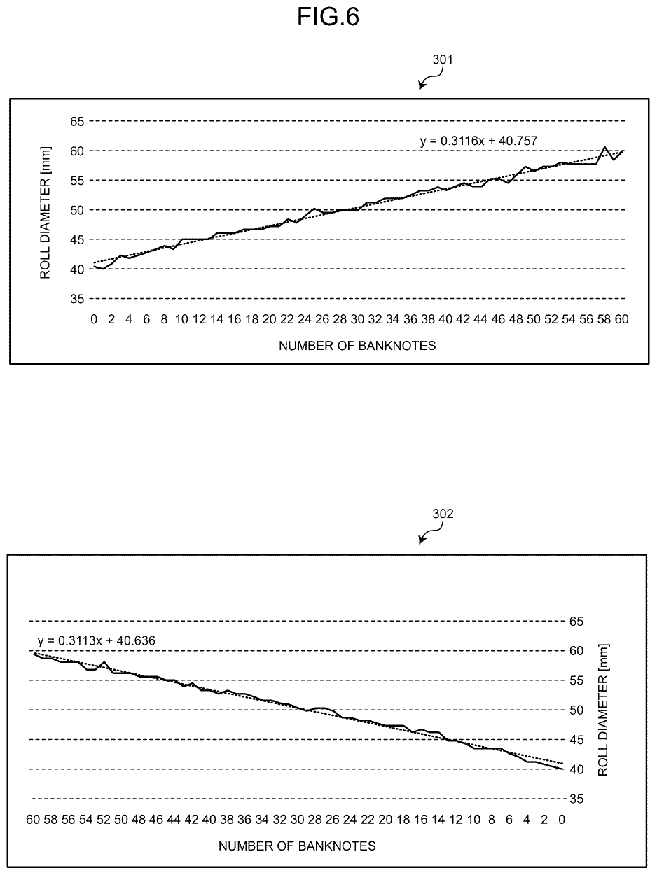

By counting the number of banknotes stored in the roll 51 and measuring the diameter of the roll 51 in a state with that number, the number of banknotes and an actually measured value of the diameter of the roll 51 are acquired, the actually measured value corresponding to that number of banknotes. FIG. 6 is a diagram illustrating relations between the numbers of banknotes and diameters of a roll upon deposits and withdrawals. A graph 301 represents the relation between the numbers of banknotes and the diameters of the roll 51 upon the deposits and a graph 302 represents the relation between the numbers of banknotes and the diameters of the roll 51 upon the withdrawals. The horizontal axis represents the number of banknotes and the vertical axis represents the diameter of the roll 51, in both of the graphs 301 and 302. As illustrated by the graphs 301 and 302, a regression line representing a relation between the number of banknotes and the diameter of the roll 51 is able to be generated from the actually measured values. Equations in the graphs 302 and 301 are equations of their respective regression lines.

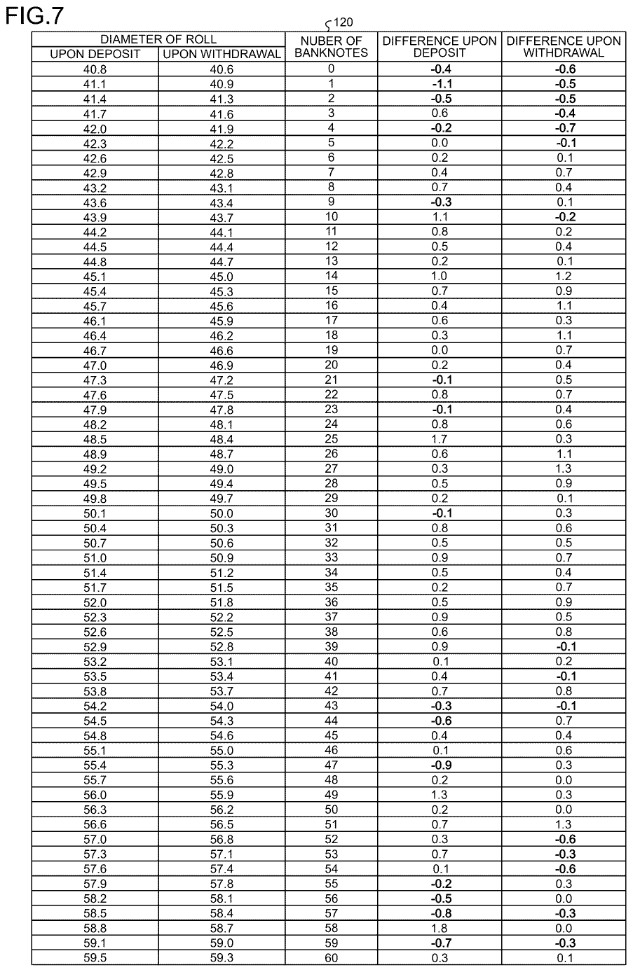

FIG. 7 is a diagram illustrating an example of a table for conversion from diameters of the roll to the numbers of banknotes. The physical storage amount increase and decrease calculation unit 102 has a conversion table 120 for the numbers of banknotes from diameters of the roll 51, the conversion table 120 being based on approximate equations obtained from the graphs 301 and 302. Roll diameters in the conversion table 120 are values expected to be diameters obtained from the regression lines of the graphs 301 and 302. Furthermore, differences upon deposits and differences upon withdrawals in the conversion table 120 each represent a difference between an expected value and an actually measured value. The largest difference upon deposits is 1.8 and the largest difference upon withdrawals is 1.3 and the diameters upon the withdrawals in the conversion table 120 were used for conversion into the numbers of banknotes. In this embodiment, the physical storage amount increase and decrease calculation unit 102 uses this one conversion table 120 for both deposits and withdrawals, but different tables may be used for deposits and withdrawals.

In a case where a diameter of the roll 51 is converted into the number of banknotes, in addition to an actually measured value from an actual storage history, any one or combination of the size of the banknotes, the size of the transparent window if the banknotes are polymer banknotes, or the thickness of the banknotes may be used. In this case, the conversion table 120 is adjusted by these values.

The physical storage amount increase and decrease calculation unit 102 acquires the number of banknotes corresponding to a diameter of the roll 51 acquired from the latest log data 201, from the conversion table 120. Furthermore, the physical storage amount increase and decrease calculation unit 102 holds the previously calculated physical storage amount for the roll 51. The physical storage amount increase and decrease calculation unit 102 then calculates an increase or decrease in physical storage amount by subtracting the previously calculated physical storage amount for the roll 51 from the physical storage amount for the roll 51 calculated this time.

Furthermore, similarly, the physical storage amount increase and decrease calculation unit 102 calculates an increase or decrease in physical storage amount for each of the rolls 52 to 54. The physical storage amount increase and decrease calculation unit 102 then outputs the calculated increase or decrease in physical storage amount for each of the rolls 51 to 54, to the detection unit 104. This increase or decrease in physical storage amount corresponds to an example of a “second increase or decrease”.

The detection unit 104 has a detection threshold beforehand, the detection threshold being for detecting cash loss. The detection threshold is a threshold for a difference between an increase or decrease in logical storage amount and an increase or decrease in physical storage amount. That is, in a case where the difference between the increase or decrease in logical storage amount and the increase or decrease in physical storage amount is larger than the threshold, the detection unit 104 detects cash loss. The larger the threshold, the smaller the detection frequency and the higher the possibility of missing cash loss. Conversely, the smaller the threshold, the larger the detection frequency and the more frequently cash loss is detected erroneously. Therefore, the threshold is preferably determined according to the use. In this embodiment, the detection threshold has a positive value.

For example, the detection threshold may be determined by using any one or combination of an actually measured value from an actual storage history, the size of banknotes, the size of the transparent window if the banknotes are polymer banknotes, or the thickness of the banknotes. Furthermore, in a case where a jam occurs, the detection unit 104 may adjust the detection threshold or may determine that detection is not possible and not perform detection, on the basis of a jam occurrence history recorded in a log.

The detection unit 104 receives input of an increase or decrease in logical storage amount for each of the rolls 51 to 54 from the logical storage amount increase and decrease calculation unit 103. Furthermore, the detection unit 104 receives input of an increase or decrease in physical storage amount for each of the rolls 51 to 54 from the physical storage amount increase and decrease calculation unit 102.

The detection unit 104 then compares the absolute value of the value resulting from subtraction of the increase or decrease in physical storage amount from the increase or decrease in logical storage amount, with the detection threshold, for the roll 51. In a case where the absolute value of the value resulting from the subtraction of the increase or decrease in physical storage amount from the increase or decrease in logical storage amount is larger than the detection threshold, the detection unit 104 detects cash loss at the roll 51. For example, in a case where the detection threshold is 5 and the difference between the changes is equal to or less than −5 or equal to or larger than 5, the detection unit 104 detects cash loss at the roll 51. Similarly, the detection unit 104 detects any cash loss for the rolls 52 to 54.

In addition, the detection unit 104 may hold a lower limit threshold and an upper limit threshold and detect cash loss in a case where the difference between the changes is equal to or less than the lower limit threshold or is equal to or larger than the upper limit threshold.

In a case where cash loss is detected for any of the rolls 52 to 54, the detection unit 104 instructs the notification unit 105 to perform notification of warning for the cash loss. The detection unit 104 may instruct notification of warning for cash loss for the recycle stacker 155 and recycle stacker 156, and the rolls 52 to 54, distinctively from one another.

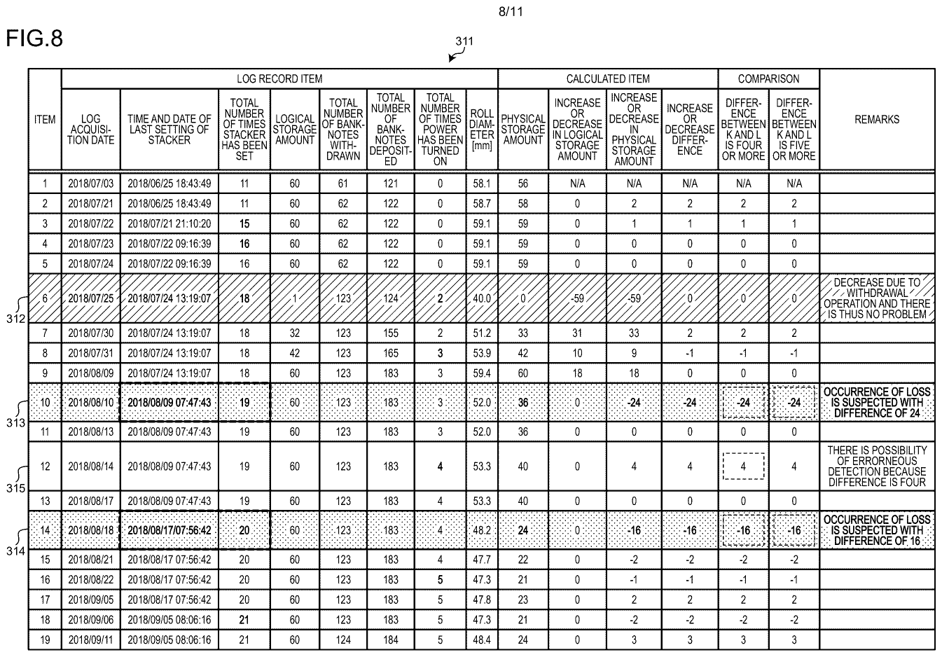

FIG. 8 is a diagram illustrating an example of detection of possibility of occurrence of cash loss. Items recorded in logs and items calculated by the physical storage amount increase and decrease calculation unit 102, the logical storage amount increase and decrease calculation unit 103, and the detection unit 104 are listed in a table 311 in FIG. 8. Furthermore, the detection of cash loss is performed for the case where the detection threshold is 5 banknotes, but the table 311 also lists a case where the detection threshold is 4 banknotes for comparison.

For example, on July 25 listed in a line 312, the increase or decrease in logical storage amount and the increase or decrease in physical storage amount are both large at −59 banknotes and cash loss may be suspected in a case where a human being takes this into consideration. However, because the difference between the increase or decrease in logical storage amount and the increase or decrease in physical storage amount is less than the detection threshold, the detection unit 104 does not detect any cash loss. The large decrease in the amount of banknotes in this case is actually a decrease due to withdrawal operation and there is no risk of cash loss.

By contrast, on August 10 listed in a line 313, the difference between the increase or decrease in logical storage amount and the increase or decrease in physical storage amount is 24 banknotes, which is equal to or larger than the detection threshold, and the detection unit 104 thus detects cash loss. Furthermore, on August 18 listed in a line 314, the difference between the increase or decrease in logical storage amount and the increase or decrease in physical storage amount is 16 banknotes, which is equal to or larger than the detection threshold, and the detection unit 104 thus detects cash loss.

However, on August 14 listed in a line 315, the difference between the increase or decrease in logical storage amount and the increase or decrease in physical storage amount is 4 banknotes. In this case, if the detection threshold is 4, the difference is equal to or larger than the detection threshold and the detection unit 104 may erroneously detect cash loss.

By referring to other logs for the cash handling apparatus 1, the detection unit 104 is able to limit the questionable time period for occurrence of cash loss. For example, the detection unit 104 may acquire a log including power information on the cash handling apparatus 1 and information on detachment and attachment of the stackers, from the storage unit 12 and limit the questionable time period for occurrence of cash loss. The detection unit 104 may notify an administrator of a determined questionable time period for cash loss via the notification unit 105. A case where the other logs for the cash handling apparatus 1 are stored in the storage unit 12 is described with respect to the embodiment but the place to store the other logs is not necessarily the storage unit 12.

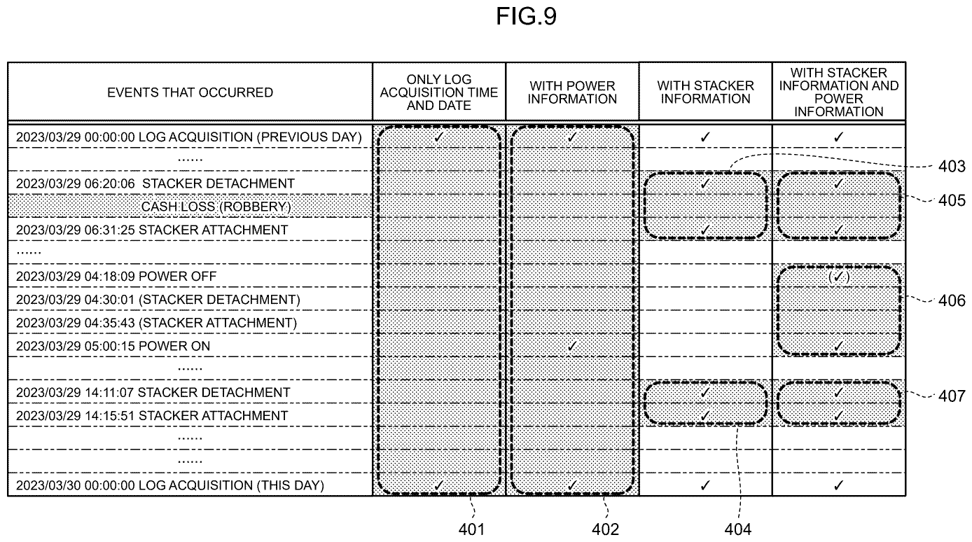

FIG. 9 is a diagram illustrating an example of questionable time periods that are able to be determined from log information. FIG. 9 illustrates events that occurred from the previous day's log acquisition to this day's log acquisition. Stacker detachment and attachment in FIG. 9 refer to detachment and attachment of any one of the recycle stacker 155 or 156. Furthermore, a case where cash loss has occurred in one of the events that have occurred and that are written in FIG. 9 is considered herein, the one being where “cash loss (robbery)” is written.

For example, the detection unit 104 regards a time period 401 as a questionable time period because only the fact that the cash loss occurred sometime between the previous log acquisition and this time's log acquisition is able to be known from the time and dates of log acquisition. Even in a case where power information is used, other events that occurred cannot be known and the detection unit 104 thus regards a time period 402 as a questionable time period. An administrator is able to apprehend that the cash loss event occurred sometime between the time of the previous log acquisition and the time of this time's log acquisition, when the administrator receives a notification of warning for the cash loss. Therefore, even if the administrator is notified of the questionable time periods, the time periods 401 and 402, these questionable time periods correspond to the entire time period between the acquisition of the logs, and the time point of the cash loss is difficult to be determined more finely.

In contrast, in a case where stacker detachment and attachment information is used, it is able to be considered that the cash loss occurred while the recycle stacker 155 or 156 was in a detached state, and the detection unit 104 is thus able to determine time periods 403 and 404 as questionable time periods. In this case, an administrator is able to determine that the cash loss occurred in the time period 403 or 404, which is shorter than the log acquisition interval. However, in a state where the power of the cash handling apparatus 1 is off, detachment and attachment of the recycle stacker 155 or 156 are not recorded in the logs. Therefore, in this case, it is difficult for the administrator to apprehend the possibility of cash loss for the state where the power is off.

By further using the power information in addition to the stacker detachment and attachment information, the detection unit 104 is thus able to detect that the recycle stacker 155 or 156 might have also been removed while the power was off and to regard time periods 405 to 407 as questionable time periods. In this case, an administrator is able to determine that the cash loss occurred in one of the time periods 405 to 407. The robbery happened in the time period 405 in this example, and the administrator is thus able to appropriately and efficiently determine the cause of the cash loss even without using the power information, but in a case where the robbery happened in the time period 406, for example, determination of the cause may be difficult without use of the power information.

As described above, the detection unit 104 is able to limit the questionable time period for occurrence of cash loss by determining the time period, in which the recycle stacker 155 or 156 was in the removed state, by using other log information. By being notified of the questionable time period for occurrence of cash loss, an administrator is able to efficiently check operator information and information recorded by a monitoring camera for the questionable time period. Furthermore, performing detection with a shorter log acquisition cycle enables further limitation of a questionable time period for occurrence of cash loss.

The notification unit 105 receives an instruction for notification of warning for cash loss, from the detection unit 104. Via the communication processing unit 19, the notification unit 105 transmits a warning message for the cash loss to the host computer 2. The notification unit 105 thereby notifies an administrator of the cash handling apparatus 1 of the warning for cash loss.

A case where the cash handling apparatus 1 has the physical storage amount increase and decrease calculation unit 102, the logical storage amount increase and decrease calculation unit 103, the detection unit 104, and the notification unit 105 has been described with respect to the embodiment, but these units may be divided to be arranged in different apparatuses respectively. For example, the host computer 2 may be configured to have the detection unit 104 and the notification unit 105 arranged therein. Furthermore, the detection unit 104 and the notification unit 105 may be arranged in a monitoring server that monitors operation of the cash handling apparatus 1, the monitoring server being different from the host computer 2 that manages information on handling of cash. In this case, the host computer 2 or the monitoring server, which has the detection unit 104 and the notification unit 105 arranged therein, acquires and holds information to be used in detection of cash loss from the physical storage amount increase and decrease calculation unit 102, the logical storage amount increase and decrease calculation unit 103, and the storage unit 12, which are arranged in the cash handling apparatus 1, and performs detection and notification of cash loss by using the information.

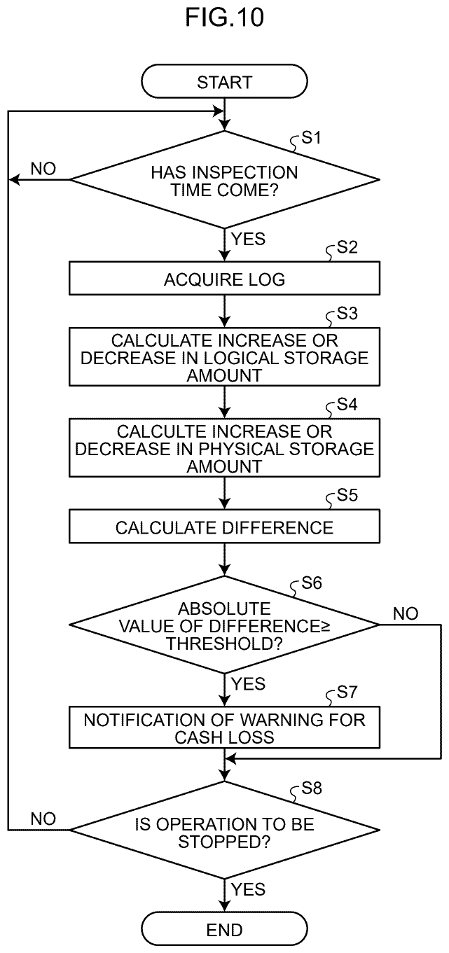

FIG. 10 is a flowchart of a cash loss detection process by the cash handling apparatus according to the embodiment. A flow of a cash loss detection process by the cash handling apparatus 1 according to the embodiment will be described next by reference to FIG. 10.

The log acquisition unit 101 determines whether or not the time for inspection for any cash loss, which is the time for log acquisition, has come (Step S1). In a case where the time for inspection has not come yet (Step S1: No), the log acquisition unit 101 waits until the time for inspection comes.

On the contrary, in a case where the time for inspection has come (Step S1: Yes), the log acquisition unit 101 acquires new log data 523 from the log storage unit 522 of the cash processing unit 150 (Step S2). The log acquisition unit 101 then stores existing latest log data 201 as previous log data 202 into the storage unit 12 and stores the newly acquired log data 523 as latest log data 201 into the storage unit 12.

The physical storage amount increase and decrease calculation unit 103 acquires this time's logical storage amount for each of the rolls 51 to 54 from the latest log data 201. Furthermore, the logical storage amount increase and decrease calculation unit 103 acquires the previous logical storage amount for each of the rolls 51 to 54 from the previous log data 202. The logical storage amount increase and decrease calculation unit 103 then subtracts the previous logical storage amount from this time's logical storage amount to calculate an increase or decrease in logical storage amount for each of the rolls 51 to 54 (Step S3).

The physical storage amount increase and decrease calculation unit 102 acquires information on respective diameters of the rolls 51 to 54 from the latest log data 201. The physical storage amount increase and decrease calculation unit 102 then calculates the physical storage amount for each of the rolls 51 to 54 by converting the diameters acquired into the numbers of banknotes using the conversion table 120. Thereafter, the physical storage amount increase and decrease calculation unit 102 subtracts the previous physical storage amount from this time's physical storage amount to calculate an increase or decrease in physical storage amount for each of the rolls 51 to 54 (Step S4).

The detection unit 104 calculates the difference between the increase or decrease in logical storage amount and the increase or decrease in physical storage amount for each of the rolls 51 to 54 (Step S5).

Subsequently, the detection unit 104 determines whether or not the absolute value of the found difference between the increase or decrease in logical storage amount and the increase or decrease in physical storage amount is equal to or larger than a detection threshold (Step S6).

In a case where the absolute value of the difference is less than the detection threshold (Step S6: No), the cash loss detection process is advanced to Step S8.

On the contrary, in a case where the absolute value of the difference is equal to or larger than the detection threshold (Step S6: Yes), the notification unit 105 transmits, via the communication processing unit 19, a warning message for cash loss, to the host computer 2. The notification unit 105 thereby notifies an administrator of the cash handling apparatus 1 of warning for cash loss (Step S7).

Thereafter, the log acquisition unit 101 determines whether or not operation is to be stopped according to whether or not the power of the cash handling apparatus 1 has been turned off, for example (Step S8). In a case where the operation is not to be stopped (Step S8: No), the cash loss detection process is returned to Step S1. On the contrary, in a case where the operation is to be stopped (Step S8: Yes), the log acquisition unit 101 ends collection of logs and ends the cash loss detection process.

As described above, the cash handling apparatus according to the embodiment calculates: an increase or decrease in the logical number of stored banknotes calculated from entrance and exit of banknotes to and from the recycle stacker, the entrance and exit being acquired from a log; and an increase or decrease in the physical number of stored banknotes found from physical quantity that varies according to the number of banknotes stored, the physical quantity being, for example, the diameter of the roll. In a case where the difference between the increase or decrease in the logical number of stored banknotes and the increase of decrease in the physical number of stored banknotes is equal to or larger than a threshold, the cash handling apparatus detects possibility of occurrence of cash loss and performs notification of warning for the cash loss.

The possibility of occurrence of cash loss is thus able to be detected without a close inspection and the detection process is able to be performed in a short period of time without cash being taken out from the cash processing unit. Furthermore, the possibility of occurrence of cash loss is able to be detected at the time of log acquisition, the time period between the actual occurrence of the loss and the detection is thus able to be shortened, and determination of the cause of the cash loss and determination of the time and date of the occurrence are thus able to be facilitated. Therefore, security of the cash handling apparatus is able to be improved.

### Modified Example

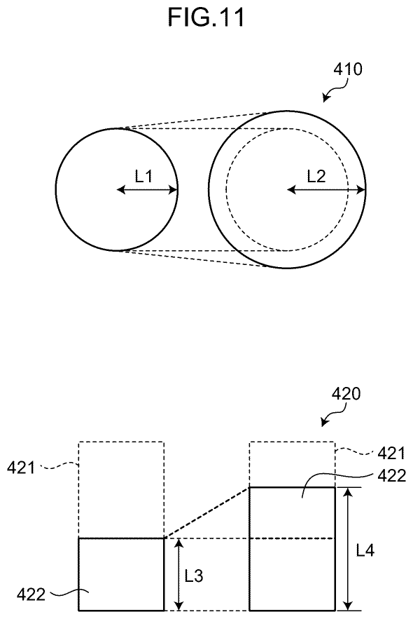

FIG. 11 is a diagram illustrating differences between banknote storage methods for a roll-type banknote storage mechanism and a stacking-type banknote collection mechanism. The recycle stacker 155 having the roll-type banknote storage mechanism has been described as an example with respect to the embodiment. However, recycle stackers include, in addition to those having roll-type banknote storage mechanisms, those having stacking-type banknote storage mechanisms.

A banknote storage mechanism 410 in FIG. 11 represents a roll-type mechanism and a banknote storage mechanism 420 in FIG. 11 represents a stacking-type mechanism. The diameter of a roll in the roll-type banknote storage mechanism 410 increases, for example, from a length L1 to a length L2, when the amount of banknotes stored increases, as described with respect to the embodiment.

By contrast, in the stacking-type banknote storage mechanism 420, banknotes 422 are stacked up in a storage box 421. Therefore, in the stacking-type banknote storage mechanism 420, when the amount of banknotes stored increases, the thickness of the banknotes stacked up increases, for example, from a length L3 to a length L4.

For the stacking-type banknote storage mechanism 420, a sensor to detect the thickness of banknotes stacked up in the storage box 421 is thus arranged. A physical storage amount increase and decrease calculation unit 102 is able to calculate a physical storage amount by finding the number of banknotes stacked up, from a thickness of the banknotes detected by the sensor. In this case, the physical storage amount increase and decrease calculation unit 102 may use, for example, a conversion table for converting the thickness of the banknotes stacked up into the number of banknotes. The physical storage amount increase and decrease calculation unit 102 is then able to calculate an increase or decrease in physical storage amount by using the value for this time and the previous value, of the physical storage amounts found from the thicknesses of the banknotes.

As described above, a cash handling apparatus according to a modified example is also able to detect possibility of occurrence of cash loss in a case where a recycle stacker having a stacking-type banknote storage mechanism is used. Therefore, the cash handling apparatus including the recycle stacker having the stacking-type banknote storage mechanism also enables the security to be improved.

Furthermore, in each example described above, a roll diameter is used as physical quantity for finding a physical storage amount for the roll-type, and a thickness of banknotes is used for the stacking-type, but without being limited to these examples, any other information that is physical quantity that changes according to a physical storage amount may be used to find a physical storage amount. For example, for any of the roll-type or the stacking-type, the physical storage amount increase and decrease calculation unit 102 may calculate an increase or decrease in physical storage amount by using the weight of the whole stacker. In this case, the logical storage amount increase and decrease calculation unit 103 calculates the increase or decrease in physical storage amount by using the weight of the storage part, such as the roll 51 or the storage box 421, and a table for converting the weight into the number of banknotes. By comparing the increase or decrease in physical storage amount and the increase or decrease in logical storage amount, the detection unit 104 is able to detect cash loss, similarly to each example.

An effect achieved according to one aspect of a cash handling apparatus, a cash handling method, and a cash handling program disclosed by the present application is to enable security of cash management to be improved.

What is claimed is

1. A cash handling apparatus, comprising:
a banknote storage that stores banknotes;
a memory; and
a processor coupled to the memory and configured to:
calculate a first increase or decrease on the basis of information on entrance and exit of banknotes to and from the banknote storage;
calculate a second increase or decrease on the basis of physical quantity that varies according to the number of banknotes stored in the banknote storage; and
detect possibility of banknote loss on the basis of the first increase or decrease and the second increase or decrease.

2. The cash handling apparatus according to claim 1, wherein the processor is further configured to,
periodically acquire logs of operation including the information on entrance and exit, for a cash processing device having the banknote storage, and
calculate the first increase or decrease on the basis of a log acquired.

3. The cash handling apparatus according to claim 1, wherein
the banknote storage has a roll that stores banknotes wound around the roll, and
the processor is further configured to calculate the second increase or decrease on the basis of a diameter of the roll having the banknotes wound around the roll.

4. The cash handling apparatus according to claim 1, wherein
the banknote storage has a storage box that stores banknotes stacked up in the storage box, and
the processor is further configured to calculate the second increase or decrease on the basis of a thickness of banknotes stacked up in the storage box.

5. A computer implemented cash handling method comprising:
calculating a first increase or decrease on the basis of information on entrance and exit of banknotes to and from a banknote storage;
calculating a second increase or decrease on the basis of physical quantity that varies according to the number of banknotes stored in the banknote storage; and
detecting possibility of banknote loss on the basis of the first increase or decrease and the second increase or decrease, by a processor.

6. A non-transitory computer-readable recording medium having stored therein a cash handling program that causes a computer to execute a process comprising:
calculating a first increase or decrease on the basis of information on entrance and exit of banknotes to and from a banknote storage;
calculating a second increase or decrease on the basis of physical quantity that varies according to the number of banknotes stored in the banknote storage; and
detecting possibility of banknote loss on the basis of the first increase or decrease and the second increase or decrease.
